(19) United States
(12) Patent Application Publication
(10) Pub. No.: US 2011/0199590 A1
(43) Pub. Date: Aug. 18, 2011

(54) PROJECTION DISPLAY DEVICE, TERMINAL COVER, AND COVER UNIT

(75) Inventors: Yusuke YAMAMOTO, Osaka-city (JP); Yuji Hashiba, Kizugawa-city (JP); Toshihiro Saruwatari, Kishiwada-city (JP)

(73) Assignee: Sanyo Electric Co., Ltd., Moriguchi-city (JP)

(21) Appl. No.: 13/028,881

(22) Filed: Feb. 16, 2011

(30) Foreign Application Priority Data
Feb. 18, 2010 (JP) 2010-034019

(51) Int. Cl. G03B 21/14

(52) U.S. Cl. 353/119

(57) ABSTRACT

A projection display device includes a terminal which is disposed on a surface of a main body cabinet, and a terminal cover which is attached to the surface of the main body cabinet to cover the terminal connected to a cable. In this arrangement, the terminal cover is formed with an opening portion on a surface thereof for passing the cable therethrough, the surface of the terminal cover facing upward when the projection display device is installed in a suspended state.

This application claims priority under 35 U.S.C. Section 119 of Japanese Patent Application No. 2010-034019 filed Feb. 18, 2010, entitled “PROJECTION DISPLAY DEVICE, TERMINAL COVER, AND COVER UNIT”. The disclosure of the above application is incorporated herein by reference.

### BACKGROUND OF THE INVENTION

1. Field of the Invention

The present invention relates to a projection display device for enlarging and projecting light modulated by an imager onto a projection plane, and a terminal cover and a cover unit are attached to the projection display device.

2. Disclosure of Related Art

Conventionally, in a projection display device (hereinafter, called as a “projector”), various terminals such as AV terminals are disposed on a surface (e.g. a rear surface, a left side surface, or a right side surface) of a main body cabinet. The AV terminals are connected to cables for transmitting image signals and audio signals. The image signals and the audio signals are inputted to and outputted from the projector through the terminals.

The projector may be installed in a suspended state from e.g. a ceiling of a room, other than installation on a table or on a floor surface. In the above installation manner, the projector may be suspended from the ceiling in an upside down state, and become a part of the interior of the room. Accordingly, in the above installation manner, it is necessary to enhance the appearance of the projector.

However, as described above, if various terminals are disposed on the rear surface, the left side surface, or the right side surface of the main body cabinet, the terminals may be exposed to the outside, and the cables to be connected to the terminals may be viewed from below. As a result, the appearance of the projector may be degraded, which may impair the appearance of the room. Normally, in the installation manner that the projector is suspended from e.g. a ceiling, the projector is constantly kept in an installed state. Accordingly, it is desirable to enhance the appearance of the projector by making the parts such as the terminals and the cables less perceivable when the projector is viewed from below.

### SUMMARY OF THE INVENTION

A projection display device according to a first aspect of the invention includes a terminal which is disposed on a surface of a main body cabinet, and a terminal cover which is attached to the surface of the main body cabinet to cover the terminal connected to a cable. In this arrangement, the terminal cover is formed with an opening portion on a surface thereof for passing the cable therethrough. The surface of the terminal cover faces upward when the projection display device is installed in a suspended state.

A terminal cover according to a second aspect of the invention covers a terminal disposed on a surface of a projection display device in a state that the terminal is connected to a cable. In this arrangement, the terminal cover is formed with an opening portion on a surface thereof for passing the cable therethrough. The surface of the terminal cover faces upward when the projection display device is installed in a suspended state.

A terminal cover unit according to a third aspect of the invention includes a terminal cover which covers a terminal disposed on a surface of a projection display device in a state that the terminal is connected to a cable; and an inner cover which is attached to the surface of the projection display device, and which is placed inside the terminal cover. In this arrangement, the inner cover is formed with a bulging portion, and a recess portion. The recess portion is overlapped with the terminal cover with a smaller thickness than an overlapped thickness of the bulging portion and the terminal cover. The recess portion is formed with a window portion through which the terminal is exposed in the terminal cover. The terminal cover is formed with an opening portion on a surface thereof for passing the cable therethrough. The surface of the terminal cover faces upward when the projection display device is installed in a suspended state.

### BRIEF DESCRIPTION OF THE DRAWINGS

These and other objects, and novel features of the present invention will become more apparent upon reading the following detailed description of the embodiment along with the accompanying drawings.

FIGS. 1A and 1B are perspective views showing an external arrangement of a projector embodying the invention.

FIGS. 2A and 2B are perspective views showing an internal arrangement of the projector as the embodiment.

FIG. 3 is a diagram showing an arrangement of an optical engine and a projection lens unit in the embodiment.

FIG. 4 is a diagram showing an arrangement of a cover unit in the embodiment.

FIGS. 5A and 5B are diagrams showing an arrangement of an inner cover in the embodiment.

FIG. 6 is a diagram showing an arrangement of the inner cover in the embodiment.

FIG. 7 is a diagram showing an arrangement of the inner cover in the embodiment.

FIG. 8 is a diagram showing an arrangement of a terminal cover in the embodiment.

FIGS. 9A and 9B are diagrams for describing a structure of a right side portion of a main body cabinet in the embodiment.

FIGS. 10A and 10B are diagrams showing a state that the inner cover is attached to the main body cabinet in the embodiment.

FIGS. 11A and 11B are diagrams showing a state that the terminal cover is attached to the main body cabinet in the embodiment.

FIGS. 12A and 12B are diagrams showing a state that the terminal cover is attached to the main body cabinet in the embodiment.

The drawings are provided mainly for describing the present invention, and do not limit the scope of the present invention.

### DESCRIPTION OF PREFERRED EMBODIMENTS

In the following, an embodiment of the invention is described referring to the drawings.

In this embodiment, a central portion 151 corresponds to a recess portion in the claims. A front portion 152 corresponds to a bulging portion in the claims. A rear portion 153 corresponds to a bulging portion in the claims. The description regarding the correspondence between the claims and the embodiment is merely an example, and the claims are not limited by the description of the embodiment.

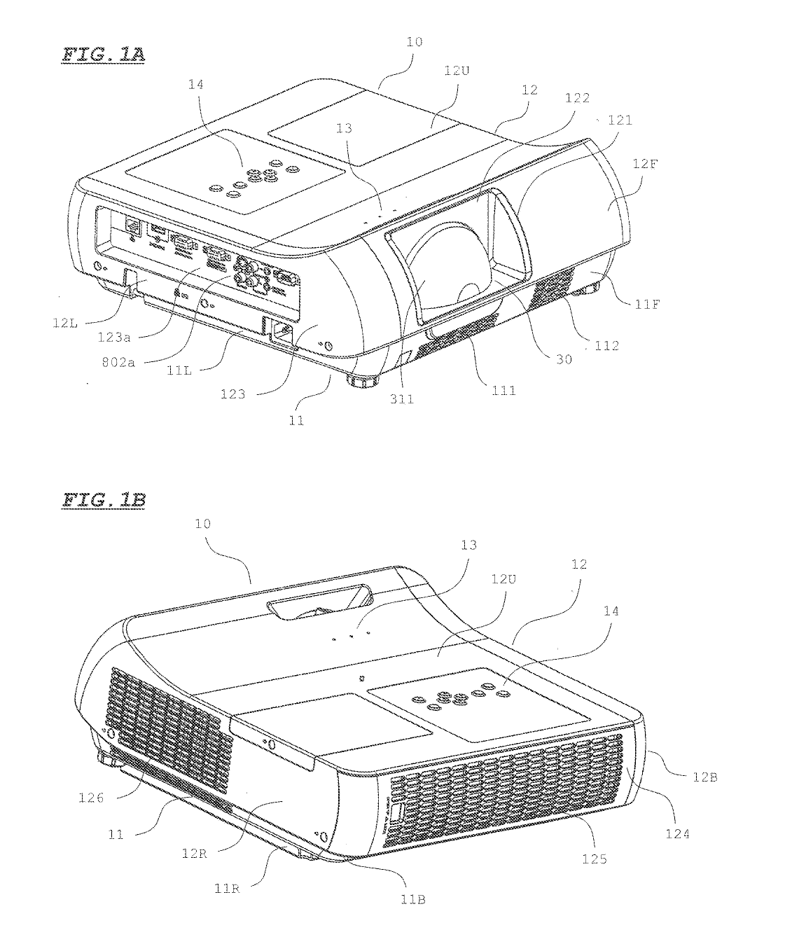

FIGS. 1A and 1B are perspective views showing an external arrangement of a projector. FIG. 1A is a perspective view of the projector when viewed from a front side thereof, and FIG. 1B is a perspective view of the projector when viewed from a rear side thereof.

Referring to FIGS. 1A and 1B, the projector is provided with a main body cabinet 10. The main body cabinet 10 is constituted of a lower cabinet 11, and an upper cabinet 12 to be covered onto the lower cabinet 11 from above.

The lower cabinet 11 has a box-like shape with a small height, and an upper surface thereof is opened. The lower cabinet 11 is configured in such a manner that a front surface 11F is higher than a left side surface 11L, a right side surface 11R, and a back surface 11B. The left side surface 11L and the right side surface 11R are configured in such a manner that front ends thereof gradually rise, and are continued to the front surface 11F.

The front surface 11F of the lower cabinet 11 is formed with an air inlet 111. The air inlet 111 is constituted of multitudes of slit holes. The front surface 11F of the lower cabinet 11 is further formed with a sound output port 112. Sounds in accordance with images are outputted through the sound output port 112 at the time of image projection.

The upper cabinet 12 has a box-like shape, and a lower surface thereof is opened. A front portion of the upper cabinet 12 is gradually curved upward over the entirety in left and right directions, and a front surface 12F thereof is directed slightly obliquely upward. The front surface 12F of the upper cabinet 12 is gradually curved when viewed from a lateral direction thereof, and is protruded obliquely upward from the front surface 11F of the lower cabinet 11.

The front surface 12F of the upper cabinet 12 is formed with a rectangular projection port 121 at a position closer to the left side surface of the upper cabinet 12 with respect to the center thereof. A housing portion 122 for housing a lens 311 corresponding to a front end of a projection lens unit 30 is formed at a rear position of the projection port 121.

A left side surface 12L of the upper cabinet 12 is constituted of a side cover 123. The side cover 123 is fixed to the main body of the upper cabinet 12 and to the lower cabinet 11 by screws. The side cover 123 is formed with a terminal housing portion 123a, and various terminals 802a such as AV terminals are exposed in the terminal housing portion 123a. AV (Audio Visual) signals such as an audio signal and an image signal or the like are inputted to and outputted from the projector via the AV terminals 802a.

A back surface 12B of the upper cabinet 12 is constituted of a detachable rear cover 129. The rear cover 129 is formed with an air inlet 125. The air inlet 125 is constituted of multitudes of slit holes. A right side surface 12R of the upper cabinet 12 is formed with an air outlet 126. The air outlet 126 is constituted of multitudes of slit holes. An external air drawn into the main body cabinet 10 through the air inlet 125 and the air inlet 111 of the lower cabinet 11 is discharged through the air outlet 126 after cooling heat generating parts disposed in the main body cabinet 10, such as liquid crystal panels and a light source lamp.

An upper surface 12U of the upper cabinet 12 is formed with an indicator portion 13 and an operation portion 14. A certain number of display windows are formed in the indicator portion 13, and light from an LED is emitted through the corresponding display window. The user is allowed to confirm whether the projector is in an operating state or in a standby state, and is also allowed to confirm various error states by emission states of each display window. A certain number of operation keys are provided on the operation portion 14.

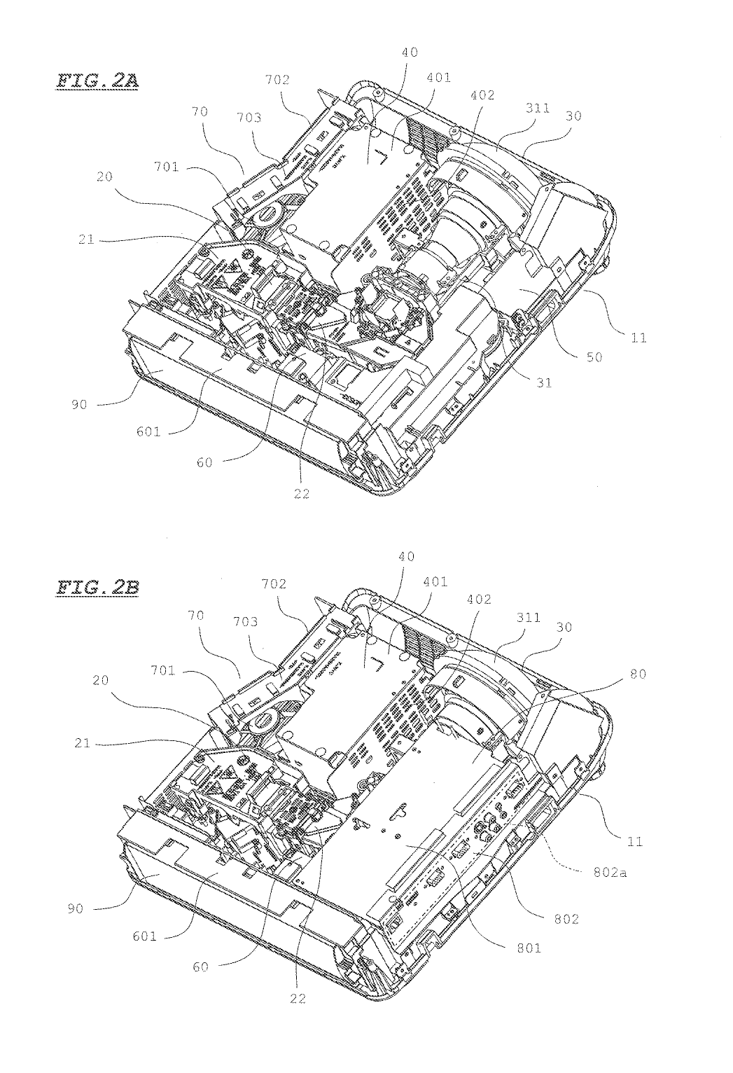

FIGS. 2A and 2B are perspective views showing an internal arrangement of the projector. FIG. 2A is a perspective view of the projector showing a state that the upper cabinet 12 and a control circuit unit 80 are detached, when viewed from the rear side thereof. FIG. 2B is a perspective view of the projector showing a state that the control circuit unit 80 is attached and only the upper cabinet 12 is detached, when viewed from the rear side thereof.

Referring to FIG. 2A, the lower cabinet 11 is internally provided with an optical engine 20, a projection lens unit 30, a main power source unit 90, a sub power source unit 50, a cooling unit 60, and an exhaust fan unit 70.

The optical engine 20 is provided with a light source portion 21 having a light source lamp, and an optical system 22 for modulating light from the light source portion 21 to generate image light. The optical engine 20 is disposed slightly rearward with respect to the center of the lower cabinet 11. The optical system 22 extends from the light source portion 21 to the projection lens unit 30 into an L-shape.

The projection lens unit 30 is disposed in front of the optical system 22, and slightly closer to the left side surface with respect to the center of the lower cabinet 11. The projection lens unit 30 is fixed to the lower cabinet 11 via a lens holder 31.

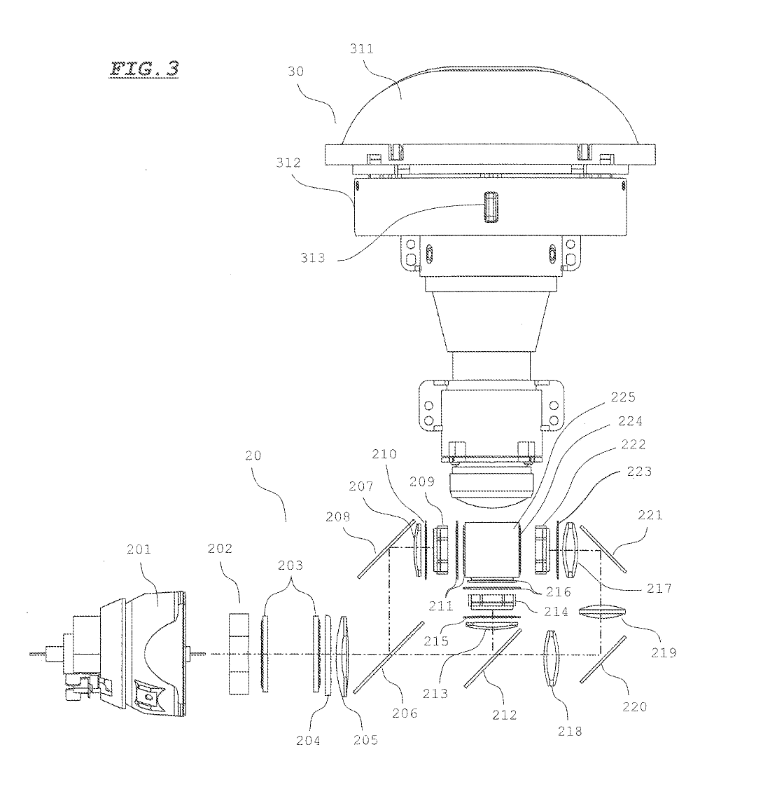

FIG. 3 is a diagram showing an arrangement of the optical engine 20 and the projection lens unit 30.

White light emitted from the light source lamp 201 is transmitted through a condenser lens 202, a fly-eye integrator 203, and a PBS array 204. The fly-eye integrator 203 is adapted to make the light amount distributions of light of the each of the colors to be irradiated onto liquid crystal panels (which will be described later) uniform, and the PBS array 204 is adapted to align polarization directions of light directed toward a dichroic mirror 206 in one direction.

Light transmitted through the PBS array 204 is transmitted through a condenser lens 205, and is entered into the dichroic mirror 206.

The dichroic mirror 206 reflects only light (hereinafter, called as “B light”) in a blue wavelength band, and transmits light (hereinafter, called as “G light”) in a green wavelength band and light (hereinafter, called as “R light”) in a red wavelength band, out of the light entered into the dichroic mirror 206.

B light reflected on the dichroic mirror 206 is irradiated onto a liquid crystal panel 209 for B light in a proper irradiation state by a lens function of the condenser lens 205 and a condenser lens 207, and reflection on a reflection mirror 208. The liquid crystal panel 209 is driven in accordance with an image signal for B light to modulate the B light depending on a driven state of the liquid crystal panel 209. One incident-side polarizer 210 is disposed on the incident side of the liquid crystal panel 209. B light is irradiated onto the liquid crystal panel 209 through the incident-side polarizer 210. Further, two output-side polarizers 211 are disposed on the output side of the liquid crystal panel 209, and B light emitted from the liquid crystal panel 209 is entered into the output-side polarizers 211.

G light and R light transmitted through the dichroic mirror 206 are entered into a dichroic mirror 212. The dichroic mirror 212 reflects the G light and transmits the R light.

G light reflected on the dichroic mirror 212 is irradiated onto a liquid crystal panel 214 for G light in a proper irradiation state by a lens function of the condenser lens 205 and a condenser lens 213. The liquid crystal panel 214 is driven in accordance with an image signal for G light to modulate the G light depending on a driven state of the liquid crystal panel 214. One incident-side polarizer 215 is disposed on the incident side of the liquid crystal panel 214, and G light is irradiated onto the liquid crystal panel 214 through the incident-side polarizer 215. Further, two output-side polarizers 216 are disposed on the output side of the liquid crystal panel 214, and G light emitted from the liquid crystal panel 214 is entered into the output-side polarizers 216.

R light transmitted through the dichroic mirror 212 is irradiated onto a liquid crystal panel 222 for R light in a proper irradiation state by a lens function of the condenser lens 205, 217, and relay lenses 218 and 219, and reflection on reflection mirrors 220 and 221. The liquid crystal panel 222 is driven in accordance with an image signal for R light to modulate the R light depending on a driven state of the liquid crystal panel 222. One incident-side polarizer 223 is disposed on the incident side of the liquid crystal panel 222, and R light is irradiated onto the liquid crystal panel 222 through the incident-side polarizer 223. Further, one output-side polarizer 224 is disposed on the output side of the liquid crystal panel 222, and R light emitted from the liquid crystal panel 222 is entered into the output-side polarizer 224.

B light, G light, and R light modulated by the liquid crystal panels 209, 214, and 222 are transmitted through the output-side polarizers 211, 216, and 224, and entered into a dichroic prism 225. The dichroic prism 225 reflects B light and R light, and transmits G light, out of the B light, the G light, and the R light, to thereby combine the B light, the G light, and the R light. Thus, image light after the color combination is projected toward the projection lens unit 30 from the dichroic prism 225.

The projection lens unit 30 is provided with a certain number of lenses, and is adapted to enlarge and project the entered image light onto a screen. The projection lens unit 30 is configured as a short focal length type, and a large sized lens 311 is included at a front end of the projection lens unit 30. Image light is emitted slightly obliquely upward from the lens 311.

The projection lens unit 30 is further provided with a focus ring 312. The focus ring 312 is formed with a focus lever 313. When the focus lever 313 is operated, the focus ring 312 is pivotally moved, and a focus lens (not shown) disposed in the projection lens unit 30 is moved in association with the focus ring 312. Thus, by operating the focus lever 313, focus for a projected image is adjusted.

Referring back to FIG. 2A, the main power source unit 40 is disposed on the right side of the projection lens unit 30, and the sub power source unit 50 is disposed on the left side of the projection lens unit 30. The main power source unit 40 is provided with a power source circuit within a housing 401, and supplies an electric power to each of the electrical components of the projector. The housing 401 is formed with a vent 402 constituted of multitudes of holes on a side surface thereof on the side of the projection lens unit 30. Another vent (not shown) is formed on the opposite side surface of the housing 401.

The sub power source unit 50 is provided with a noise filter and a smoothing circuit, and supplies an electric power from an inputted commercial AC power source to the main power source unit 40 after noise removal.

The cooling unit 60 is disposed behind the optical engine 20. The cooling unit 60 is provided with plural air intake fans. An air inlet portion 601 of the cooling unit 60 is formed at a rear end of the lower cabinet 11. A filter unit 90 is detachably attached to the air inlet portion 601. The filter unit 90 has filters of different mesh sizes to stepwise remove dusts or fumes in an external air drawn in through the air inlet 125 by each of the filters depending on the mesh sizes.

The cooling unit 60 supplies an external air drawn in through the air inlet 125 of the main body cabinet 10 to the main heat generating parts of the optical engine 20 such as the liquid crystal panels 209, 214, and 222 to thereby cool the heat generating parts.

The exhaust fan unit 70 is disposed on the right side of the main power source unit 40, and at a right end of the lower cabinet 11. The exhaust fan unit 70 is constituted of a first exhaust fan 701, a second exhaust fan 702, and a fan holder 703 for fixedly holding the first exhaust fan 701 and the second exhaust fan 702 to the lower cabinet 11.

The first exhaust fan 701 has an air in-take surface thereof being tilted slightly obliquely rearward with respect to the left side surface of the main body cabinet 10. The first exhaust fan 701 discharges to the outside an air that has been warmed by cooling the heat generating parts (such as the liquid crystal panels 209, 214, and 222; and the light source lamp 201) inside the optical engine 20. The first exhaust fan 701 also discharges to the outside an air that has been drawn in through the air inlet 111 (see FIG. 1A) and warmed by cooling the projection lens unit 30.

The second exhaust fan 702 has an air in-take surface thereof being directed to the main power source unit 40. The second exhaust fan 702 discharges to the outside an air that has been warmed by cooling the main power source unit 40.

Referring to FIG. 2B, the control circuit unit 80 is disposed on the side of the left side surface of the lower cabinet 11. The control circuit unit 80 is constituted of a circuit board 801, and an AV terminal substrate 802 mounted on a left end of the circuit board 801.

The circuit board 801 has a rectangular shape, with a front end and a rear end thereof extending along the longitudinal direction thereof. The circuit board 801 is mounted with a control circuit for controlling various driving components such as the liquid crystal panels 209, 214, and 222; and the light source lamp 201. The circuit board 801 is disposed above the projection lens unit 30, the optical engine 20, and a part of the cooling unit 60 with a relatively small clearance.

The terminals 802a are mounted on the AV terminal substrate 802. As described above, when the upper cabinet 12 is mounted on the lower cabinet 11, the terminals 802a are exposed in the terminal housing portion 123a.

The projector of the embodiment may be installed in an upper position of a room. The projector may be suspended from a ceiling of the room in an upside down state, and become a part of the interior of the room. In this embodiment, a cover unit K is prepared so that cables connected to the terminals 802a are less perceivable when the projector is viewed from below in a state that the projector is suspended from a ceiling.

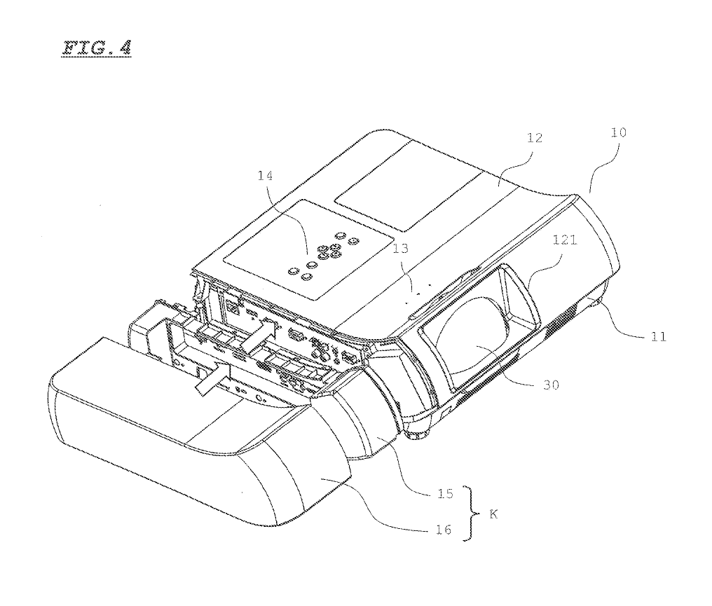

FIG. 4 is a diagram showing an arrangement of the cover unit K.

The cover unit K is constituted of an inner cover 15 and a terminal cover 16. The cover unit K is attached to the left side surface of the main body cabinet 10, in place of the side cover 123. As shown in FIG. 4, when the cover unit K is attached, the side cover 123 is detached. Firstly, the inner cover 15 is attached to the main body cabinet 10. Thereafter, the terminal cover 16 is attached to the main body cabinet 10 in such a manner as to cover the inner cover 15.

In the following, arrangements of the inner cover 15 and the terminal cover 16, and a structure as to how the inner cover 15 and the terminal cover 16 are attached to the main body cabinet 10 are described in detail.

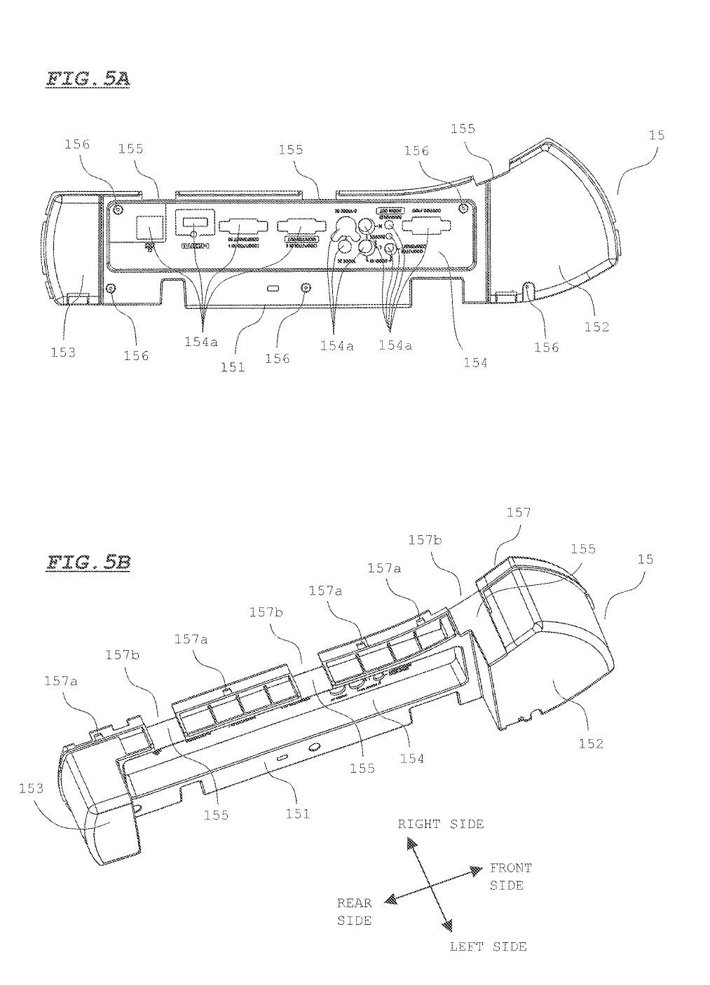

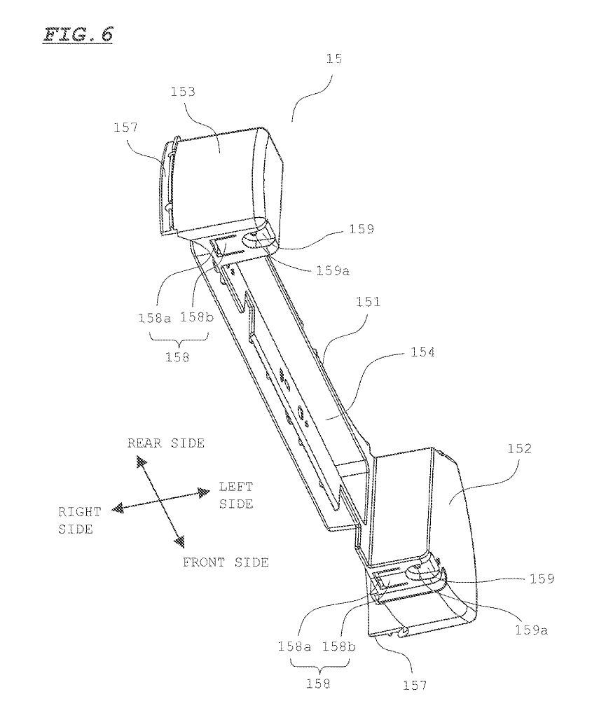

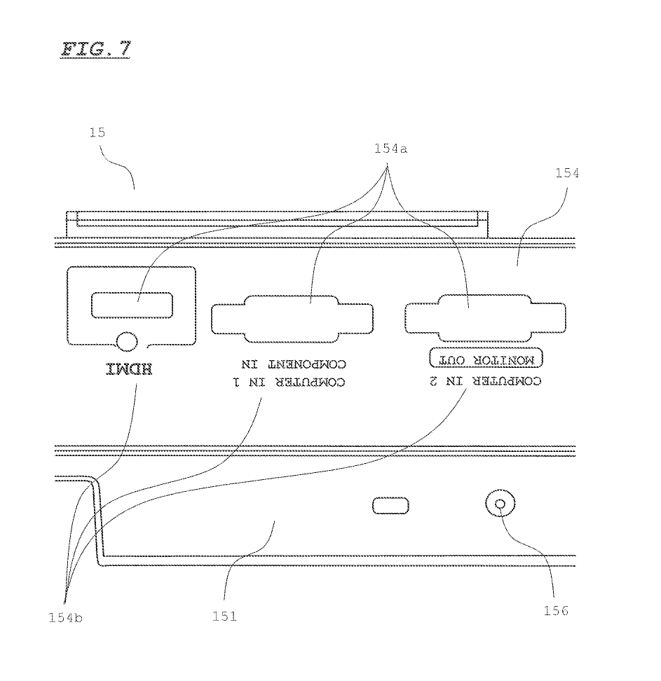

FIGS. 5A and 5B, 6, and 7 are diagrams showing an arrangement of the inner cover 15. FIG. 5A is a side view of the inner cover 15, and FIG. 5B is a perspective view of the inner cover 15, when the inner cover 15 is viewed from above. FIG. 6 is a perspective view of the inner cover 15 when the inner cover 15 is viewed from below. FIG. 7 is an enlarged view of essential parts of a terminal housing portion 154.

Referring to these drawings, the inner cover 15 has such a configuration that a front portion 152 and a rear portion 153 are bulged in the left direction with respect to a central portion 151. In other words, the central portion 151 is recessed with respect to the front portion 152 and the rear portion 153. Further, similarly to the upper cabinet 12, the inner cover 15 has such a configuration that the front portion 152 is curved upward. Furthermore, the entirety of the right side surface of the inner cover 15 is opened, and the bottom surface of the inner cover 15 is opened in accordance with the shape of the lower cabinet 11 (see FIG. 6).

The central portion 151 is formed with the terminal housing portion 159. The bottom surface of the terminal housing portion 154 is formed with window portions 154a corresponding the terminals 802a. When the inner cover 15 is attached to the main body cabinet 10, the terminals 802a are exposed to the outside through the corresponding window portions 154a.

As shown in FIG. 7, characters 154b are printed below the window portions 154a, respectively. The kind of the terminal 802a corresponding to the window portion 154a is indicated by the character of the window portion 154a. The characters 154b are printed in an upside down state. FIG. 7 shows some of the window portions 154a formed in the terminal housing portion 154, and the characters 154b corresponding to the some of the window portions 154a.

Three groove portions 155 are formed in the upper surface of the inner cover 15. When the terminal cove 16 is attached to the main body cabinet 10 and to the inner cover 15, claw pieces (to be described later) of the terminal cover 16 are passed through the groove portions 155. Five screw holes 156 are formed in the left side surface of the inner cover 15.

A flange piece 157 is formed on right ends of the front surface, the upper surface, and the rear surface of the inner cover 15. The flange piece 157 is formed with four engaging holes 157a. The flange piece 157 is further formed with cutaway portions 157b at the positions corresponding to the three groove portions 155.

As shown in FIG. 6, an engaging portion 158 and an attachment recess 159 are provided on the bottom surface of each of the front portion 152 and the rear portion 153 of the inner cover 15. Each of the engaging portions 158 is constituted of an engaging hole 158a, and a tongue portion 158b obtained by slit-shaped cut extending from both ends of the engaging portion 158a. Since the tongue portion 158b is configured to be cantilever supported, it is possible to flex the tongue portion 158b in up and down directions to some extent. Each of the attachment recesses 159 is formed with an attachment hole 159a.

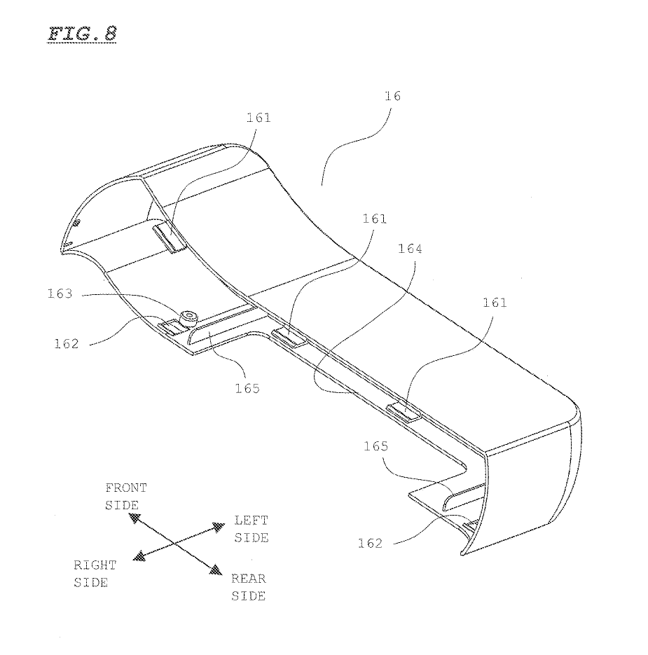

FIG. 8 is a diagram showing an arrangement of the terminal cover 16.

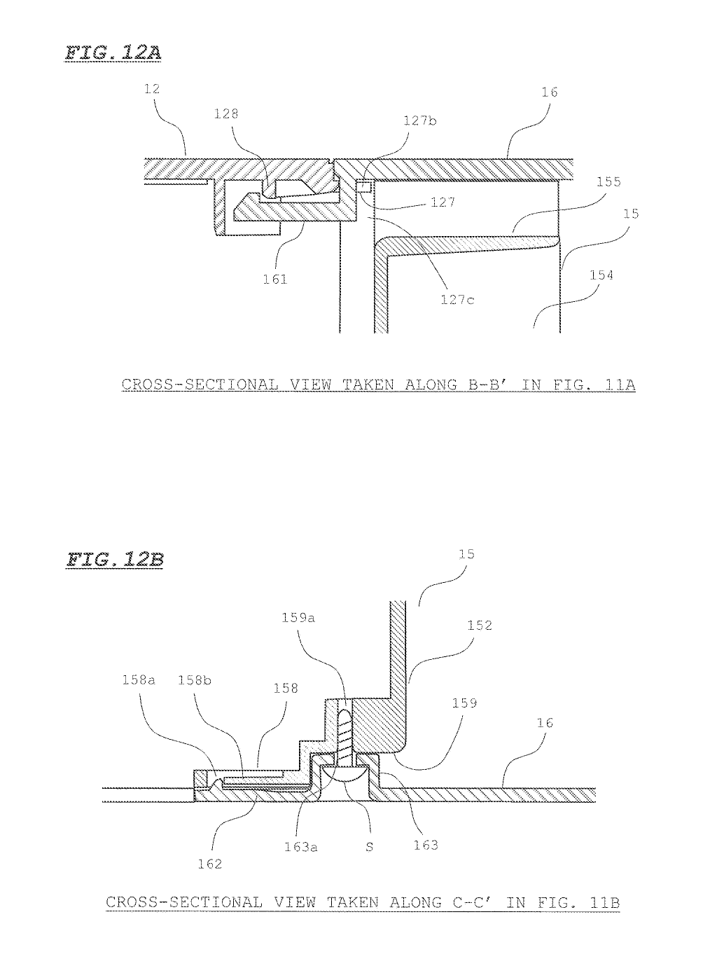

The terminal cover 16 has a box-like shape, with the entirety of the right side surface thereof being opened. Similarly to the upper cabinet 12, a front portion of the terminal cover 16 is curved upward. Three claw pieces 161 are formed on a right end on the upper surface of the terminal cover 16. Further, a claw portion 162 and a screw hole portion 163 are formed on each of a front portion and a rear portion on the bottom surface of the terminal cover 16. The screw hole portion 163 is formed in such a manner that an outer bottom surface of the terminal cover 16 is recessed (in other words, is projected inward). The screw hole portion 163 is formed with a screw hole 163a (see FIG. 12B). FIG. 8 shows only the screw hole portion 163 on the front portion of the terminal cover 16.

The bottom surface of the terminal cover 16 is further formed with an opening portion 164 extending in front and rear directions. Further, reinforcing ribs 165 are formed at both of the front end and the rear end of the opening portion 164. The vicinity of the opening portion 164 is reinforced by the reinforcing ribs 165.

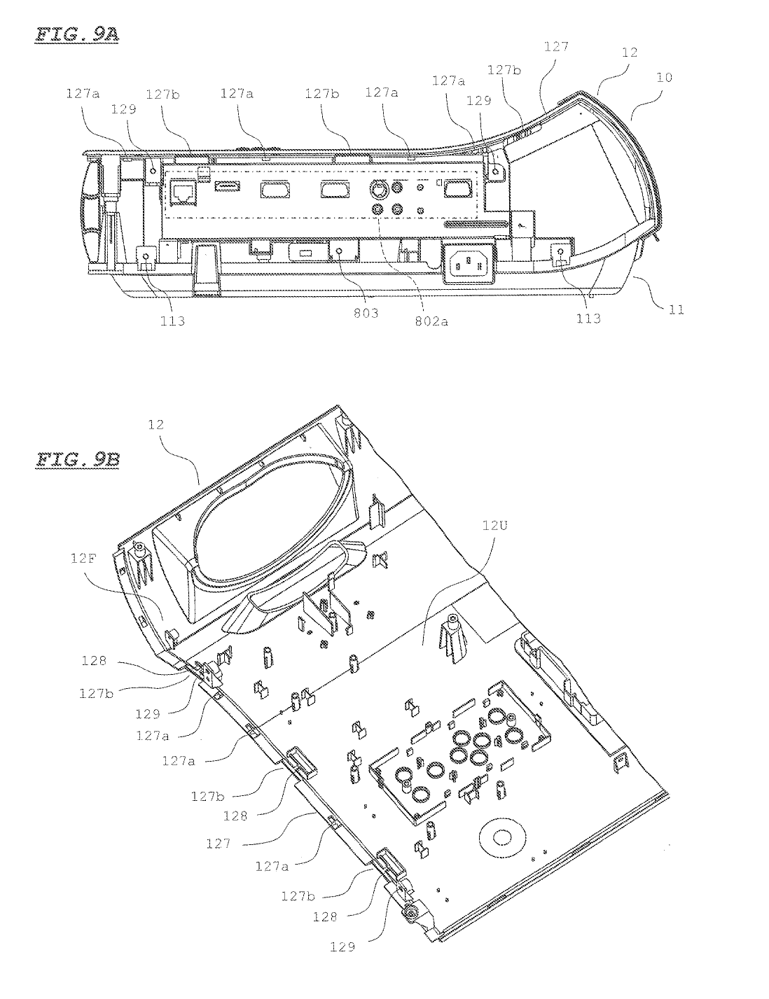

FIGS. 9A and 9B are diagrams for describing a structure of the right side portion of the main body cabinet 10. FIG. 9A is a left side view of the main body cabinet 10 in a state that the right end of the main body cabinet 10 is opened, and FIG. 9B is a diagram of a left half portion of the upper cabinet 12 whose right end is opened, when viewed from the rear side thereof.

A flange piece 127 is formed on left ends of the front surface 12F and the upper surface 12U of the upper cabinet 12. The flange piece, 127 is formed with four projections 127a to be engaged in the four engaging holes 157a. The flange piece 127 is further formed with three cutaway portions 127b at the positions corresponding to the three cutaway portions 157b of the inner cover 15. Further, engaging ribs 128 are formed adjacent to the cutaway portions 157b.

The upper cabinet 12 is formed with two attachment holes 129 for fixing the inner cover 15 by screws. Similarly, the lower cabinet 11 is formed with two attachment holes 113, and the control circuit unit 80 is formed with one attachment hole 803.

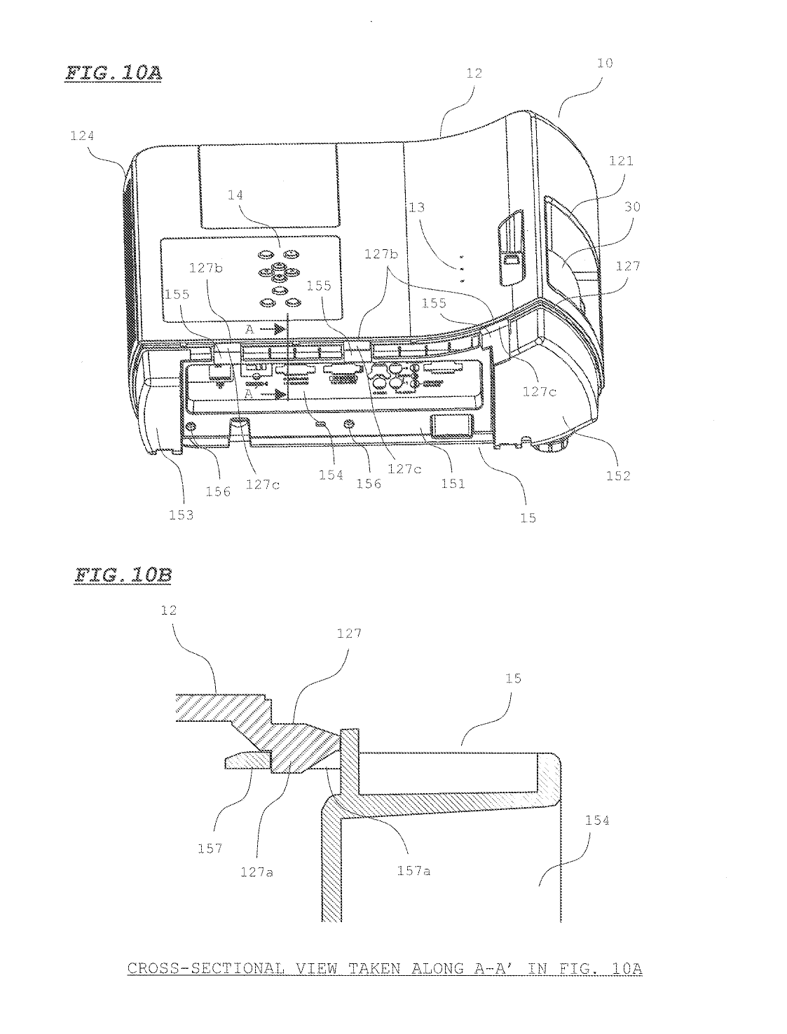

FIGS. 10A and 10B are diagrams showing a state that the inner cover 15 is attached to the main body cabinet 10. FIG. 10A is a diagram of the projector, when viewed from the upper left side. FIG. 10B is a cross-sectional view taken along the line A-A′ in FIG. 10A, and is a cross sectional view at a position where the projections 127a of the upper cabinet 12 are engaged in the engaging holes 157a of the inner cover 15. In FIG. 10A, illustration of the terminals 802a is omitted.

The inner cover 15 is attached to the main body cabinet 10 in such a manner that the flange piece 157 of the inner cover 15 is fitted inside the flange piece 127 of the upper cabinet 12. With this operation, as shown in FIG. 10B, the projections 127a of the upper cabinet 12 are engaged in the engaging holes 157a of the inner cover 15. Further, the five screw holes 156 of the inner cover 15 are aligned with the corresponding attachment holes 129, 113, and 803 on the side of the main body cabinet 10. Then, screws are fastened through the screw holes 156, and the attachment holes 129, 113, and 803, thereby fixing the inner cover 15 to the main body cabinet 10.

When the inner cover 15 is attached to the main body cabinet 10, three insertion openings 127c are defined by the three groove portions 155 of the inner cover 15, and the upper cabinet 12. The claw pieces 161 of the terminal cover 16 are received in the insertion openings 127c.

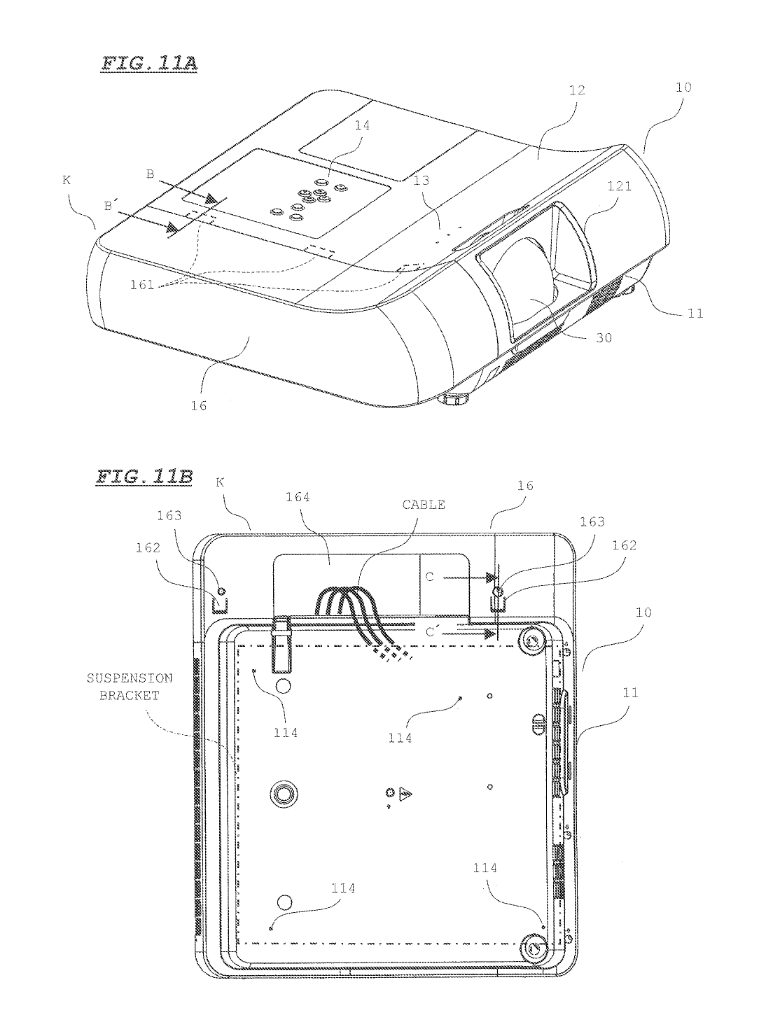

FIGS. 11A, 11B, 12A, and 12B are diagrams showing a state that the terminal cover 16 is attached to the main body cabinet 10. FIG. 11A is a perspective view of the projector, when viewed from the front direction thereof, and FIG. 11B is a bottom, view of the projector. Further, FIG. 12A is a cross-sectional view taken along the line B-B′ in FIG. 11A, and FIG. 12B is a cross-sectional view taken along the line C-C′ in FIG. 11B.

The terminal cover 16 is attached to the main body cabinet 10 in such a manner that the inner cover 15 is covered from the left side. In the attachment, the claw pieces 161 of the terminal cover 16 are passed through the corresponding groove portions 155, and then received in the main body cabinet 10 through the insertion openings 127c. As shown in FIG. 12A, the claw pieces 161 are received to such a position that distal ends thereof are mounted over the engaging ribs 128. With this operation, the claw pieces 161 are engaged with the engaging ribs 128.

Further, as shown in FIG. 12B, the claw portions 162 of the terminal cover 16 are engaged in the engaging holes 158a of the inner cover 15. Further, the screw hole portions 163 of the terminal cover 16 are received in the attachment recesses 159 of the inner cover 15, and the screw holes 163a of the screw hole portions 163 are aligned with the attachment holes 159a of the attachment recesses 159. In this arrangement, since the engaging portions 158 have the tongue portions 158b in front of the engaging holes 158a, it is possible to push and engage the claw portions 162 in the engaging holes 158a while flexing the tongue portions 158b upward by the claw portions 162. With this operation, it is possible to easily place the bottom surface side of the terminal cover 16 on the bottom surface side of the inner cover 15.

Then, the screw hole portions 163 and the attachment recesses 159 are fastened by screws S. The terminal cover 16 is fixed to the main body cabinet 10 and to the inner cover 15 by the engagement between the claw pieces 161 and the engaging ribs 128, the engagement between the claw portions 162 and the engaging holes 158a, and the screw-fastening between the screw hole portions 163 and the attachment recesses 159.

When the terminal cover 16 is attached, the inner portion of the terminal cover 16 is overlapped with the inner cover 15. In particular, the front portion and the rear portion of the terminal cover 16 are overlapped with the front portion 152 and the rear portion 153 of the terminal cover 15 by the thickness substantially equal to or larger than one-half of the size of the terminal cover 16 in left and right directions. Outer peripheral surfaces (outer surfaces in front and rear directions, and up and down directions) of the inner cover 15 is contacted with inner peripheral surfaces (inner surfaces in front and rear directions, and up and down directions) of the terminal cover 16, and the inner portion of the terminal cover 16 is supported by the inner cover 15.

As shown in FIG. 11B, four screw holes 114 are formed in the bottom surface of the lower cabinet 11. Suspension brackets are attached to the bottom surface of the lower cabinet 11 with use of the screw holes 114. The projector is suspended from a ceiling via the suspension brackets in an upside down state. When the projector is suspended in an upside down state, the bottom surface of the terminal cover 16 faces upward. The cables connected to the terminals 802a are exposed above the terminal cover 16 through the opening portion 164, and are extended on the back surface of the ceiling.

The projector is installed in such a manner that the user views the projector from below. Accordingly, the cables exposed through the opening portion 164 are less likely to be perceived by the user.

As described above, in this embodiment, since the cables connected to the terminals 802a are less likely to be perceived by the user by the attachment of the terminal cover 16, the appearance of the projector can be enhanced when the projector is installed in a suspended state from the ceiling.

Further, in the case where the projector is installed in a suspended state from the ceiling, it is possible to temporarily store the cables that are not yet connected to the terminals 802a in the terminal cover 16. With this arrangement, it is possible to enhance the workability in installing the projector in a suspended state from the ceiling.

Furthermore, in this embodiment, since the inner portion of the terminal cover 16 is supported by the inner cover 15, it is possible to firmly attach the terminal cover 16 to the main body cabinet 10. Thus, there is no or less likelihood that the terminal cover 16 may be damaged or broken, even if an unintended force is applied to the terminal cover 16 in installing the projector.

Furthermore, in this embodiment, the front portion 152 and the rear portion 153 of the inner cover 15 are configured to bulge with respect to the central portion 151 where the terminals 802a are disposed. With this configuration, since the inner portion of the terminal cover 16 is firmed supported at the front portion and the rear portion of the terminal cover 16, it is possible to firmly attach the terminal cover 16 to the main body cabinet 10. Further, since a sufficiently large space required for connecting the cables to the terminals 802a is secured at the central portion of the terminal cover 16, it is possible to smoothly connect the cables to the terminals 802a.

Furthermore, in this embodiment, the characters 154b indicating the kind of each one of the terminals 802a are printed on the inner cover 15 in an upside down state. With this arrangement, the installer is allowed to smoothly read the characters 154b indicating the kind of each one of the terminals 802a in a state that the projector is installed in an upside down state. Thus, the installer is allowed to easily connect the cables to the terminals 802a in installing the projector in a suspended state from the ceiling.

The embodiment of the invention has been described as above. The invention, however, is not limited to the foregoing embodiment, and the embodiment of the invention may be modified in various ways other than the above.

For instance, in this embodiment, the inner cover 15 is disposed inside the terminal cover 16. Alternatively, only the terminal cover 16 may be attached to the main body cabinet 10. However, as described above, it is desirable to attach the inner cover 15 to firmly attach the terminal cover 16 to the main body cabinet 10.

Further, in this embodiment, the inner cover 15 is configured so that both of the front portion 152 and the rear portion 153 are bulged in the left direction with respect to the central portion 151. Alternatively, one of the front portion 152 and the rear portion 153 may be configured to bulge.

Furthermore, in this embodiment, the terminals 802a are disposed on the left side surface of the projector. Alternatively, the terminals 802a may be disposed on a surface of the projector other than the left side surface, namely, on the right side surface or the rear surface of the projector.

The embodiment of the invention may be changed or modified in various ways as necessary, as far as such changes and modifications do not depart from the scope of the claims of the invention hereinafter defined.

What is claimed is:

1. A projection display device comprising:
a terminal which is disposed on a surface of a main body cabinet, and
a terminal cover which is attached to the surface of the main body cabinet to cover the terminal connected to a cable, wherein
the terminal cover is formed with an opening portion on a surface thereof for passing the cable therethrough, the surface of the terminal cover facing upward when the projection display device is installed in a suspended state.

2. The projection display device according to claim 1, further comprising
an inner cover which is attached to the surface of the main body cabinet, and which is placed inside the terminal cover.

3. The projection display device according to claim 2, wherein
the inner cover is formed with a bulging portion, and a recess portion, the recess portion being overlapped with the terminal cover with a smaller thickness than an overlapped thickness of the bulging portion and the terminal cover, and
the recess portion is formed with a window portion through which the terminal is exposed in the terminal cover.

4. The projection display device according to claim 2, wherein
characters indicating the kind of the terminal are printed in an upside down state on a periphery of the window portion of the inner cover.

5. A terminal cover for covering a terminal disposed on a surface of a projection display device in a state that the terminal is connected to a cable, wherein
the terminal cover is formed with an opening portion on a surface thereof for passing the cable therethrough, the surface of the terminal cover facing upward when the projection display device is installed in a suspended state.

6. A cover unit comprising:
a terminal cover which covers a terminal disposed on a surface of a projection display device in a state that the terminal is connected to a cable; and
an inner cover which is attached to the surface of the projection display device, and which is placed inside the terminal cover, wherein
the inner cover is formed with a bulging portion, and a recess portion, the recess portion being overlapped with the terminal cover with a smaller thickness than an overlapped thickness of the bulging portion and the terminal cover,
the recess portion is formed with a window portion through which the terminal is exposed in the terminal cover, and
the terminal cover is formed with an opening portion on a surface thereof for passing the cable therethrough, the surface of the terminal cover facing upward when the projection display device is installed in a suspended state.
